(19) United States
(12) Patent Application Publication
(10) Pub. No.: US 2007/0059656 A1
(43) Pub. Date: Mar. 15, 2007

(54) Rotary hanging-type candle base holder

(76) Inventor: Chih-Chung Chang, Hemei Township (TW)

Correspondence Address: TROXELL LAW OFFICE PLLC;SUITE 1404, 5205 LEESBURG PIKE, FALLS CHURCH, VA, 22041, US

(21) Appl. No.: 11/222,869

(22) Filed: Sep. 12, 2005

(51) Int. Cl. F23D 3/16; F21V 35/00

(52) U.S. Cl. 431/296

(57) ABSTRACT

A rotary hanging-type candle base holder mainly is composed of candle base and candle base holder, in which the candle base, comprising a chassis of proper weight, whose top side is designed with a bending hanging pole extending upwards. In addition a magnet unit with power magnetism absorption force is designed on the top end of the pole; the candle base holder is a three-dimensional subuliform one, in which its bottom center forms a sunken part while another end top forms a spheriform pinnacle; based on the combination of the structures above, the candle base holder may use the end of the spheriform pinnacle to be absorbed on the top side of the magnet unit, so that the handle base holder can be positioned by hanging hollowly. At this time the sunken part can provide the cross placing to stabilize the gravity center of the semi-elliptical candle box, which is used to position the candle. Based on the single-point-type magnetism absorption and position, the candle base holder can rotate freely and good candlelight effects and three-dimensional aesthetic feeling would be obtained.

### BACKGROUND OF THE INVENTION

1) Field of the Invention

This present invention relates to a rotary hanging-type candle base holder, particularly to a technique that a three-dimensional candle base holder is designed as hanging-shaped by way of magnetism absorption and hanging so that the candle box levels off its center of gravity based on the cross-placing position as well as the candle base holder can rotate smoothly and freely so as to make the candlelight assume abundant and variable aesthetic feelings.

2) Description of the Prior Art

Generally, the [candle holder] is used for a candle box so that the candle in the box will set off the halation and handle base holder while burning and take on warm and romantic atmosphere. Therefore it is widely applicable in private or public places, as the present most popular consumptive commodity. Nevertheless, the candle will go out for the deficiency in the amount of oxygen sometimes. Because it is used for placing a candle box, the design is the key so that the candle would not go out frequently in the midway of burning. That not only causes inconvenience and trouble in use, but also the burnt candle will form smoky smoke and flue gas for the incompletely burnt candle and make the user indisposed. Therefore the customers attach much importance to the function not the price while purchasing this kind of commodity whose security should be considered. On the face of it, it is the main factor whether the structure accords with the practicality for customers' favor.

### SUMMARY OF THE INVENTION

1. Problems:

(A) The candle easily goes out during burning: because the common candle base holder mostly is vertical or lying fixed structure and air in the candle box fails to flow. If the structure design cannot supply enough oxide in time at the same, the candle would easily extinguish for carelessness or the case of forgetting to wear at some urgent circumstances. Therefore the problems of being limited by security and application factors are still exist.

(B) Poor candlelight effect: the candle will fail to burn normally and take on weak light while burning under the circumstances of unstable or insufficient oxide supply; accordingly the formed candlelight would be quietly tiny and unsightly. Therefore the function is not good.

2. Countermeasures:

The present invention relates to a candle base holder, which uses magnetism absorption between topside spheriform pinnacle and magnet unit to generate rotary hanging position, and uses the sunken part at the bottom center to clip and fix a semi-elliptical candle box in which the candle can be placed. Based on the structure the halation of the candlelight can assume.

1. The candle base holder will displace by rotation and drive the around air to flow, so that the candle can obtain enough oxide and the circumstances that the candle will extinguish or burn unstably would be avoided.

2. The present invention rotates the candle base holder to make the candlelight looks beautiful like the light from firefly. Being set off by the three-dimensional holder, the beautiful candlelight and abundant and variable effects would be obtained.

### BRIEF DESCRIPTION OF THE DRAWINGS

FIG. 1 is the three-dimensional exploded view of the present invention.

FIG. 2 is the three-dimensional combination and sketch map in accordance with the present invention.

FIG. 3 is the detailed illustration map of implementing magnetism absorption in accordance with the present invention.

FIG. 4 is the sketch map of upper and lower magnetism absorption for position in accordance with the present invention.

FIG. 5 is the sketch map of another candle box's position in accordance with the present invention.

### DETAILED DESCRIPTION OF THE PREFERRED EMBODIMENTS

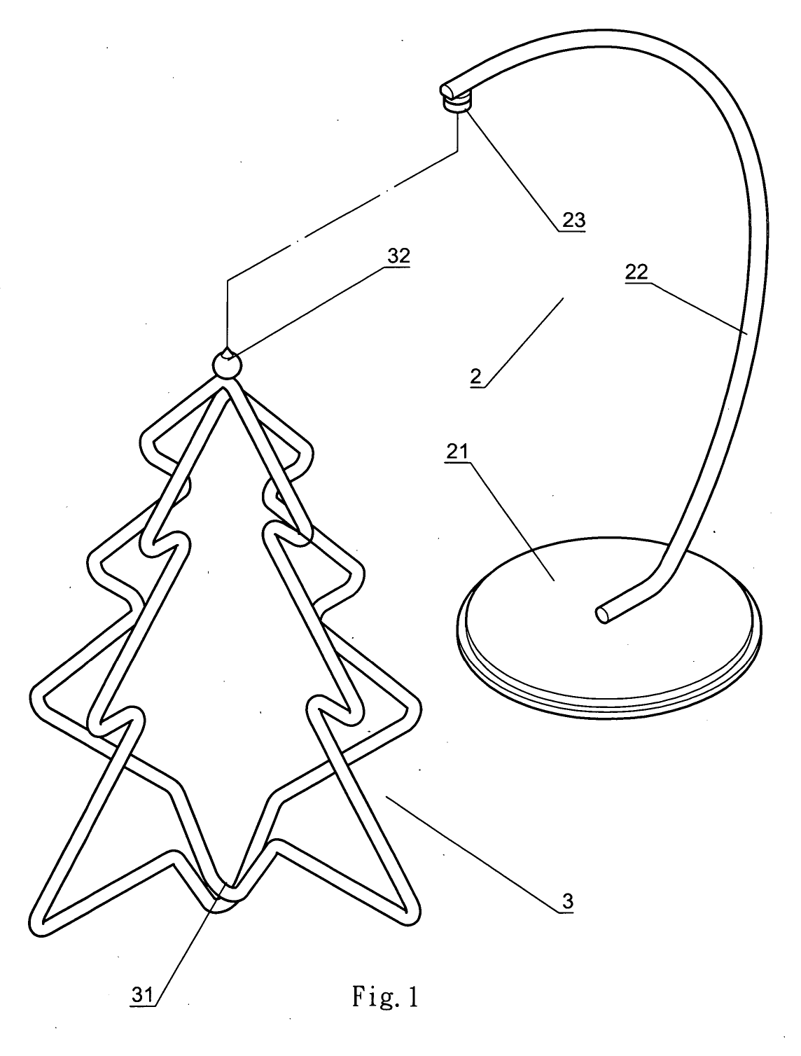

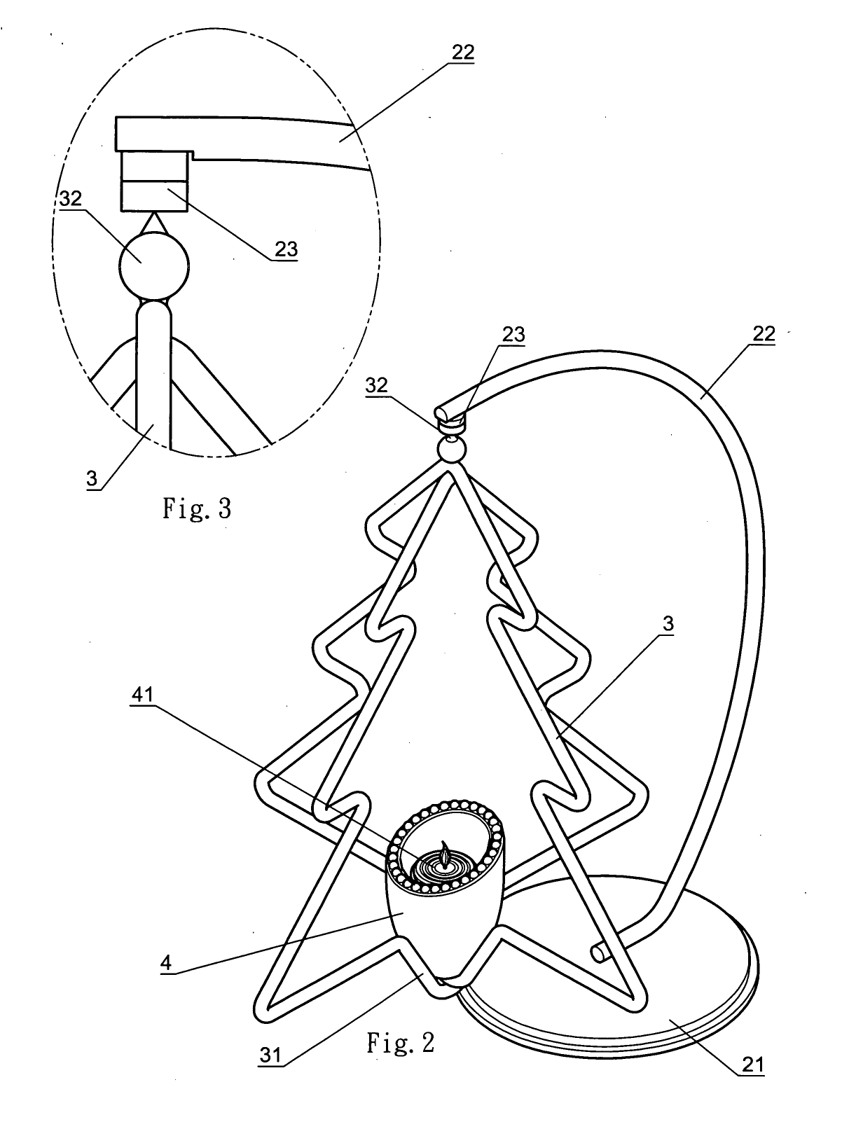

Firstly, please refer to FIG. 1, FIG. 2 and FIG. 3, the present invention mainly is composed of candle base 2 and candle base holder 3, in which:

The candle base 2, comprising a chassis 21 of proper weight, whose topside is designed with a bending hanging pole 22 extending upwards. In addition a magnet unit 23 with power magnetism absorption force is designed on the top end of the pole;

The candle base holder 3 is a three-dimensional subuliform one, in which its bottom center forms a sunken part 31 while another end top forms a spheriform pinnacle 32;

Based on the combination of the structures above, the candle base holder may use the end of the spheriform pinnacle 32 to be absorbed on the topside of the magnet unit 23 (as shown in FIG. 3), so that the handle base holder 3 can be positioned by hanging hollowly. At this time the sunken part 31 can provide the cross placing to stabilize the gravity center of the semi-elliptical candle box 4, which is used to position the candle 41. Based on the single-point-type magnetism absorption and position, the candle base holder can rotate freely and good candlelight effects and three-dimensional aesthetic feeling would be obtained (as shown in FIG. 2);

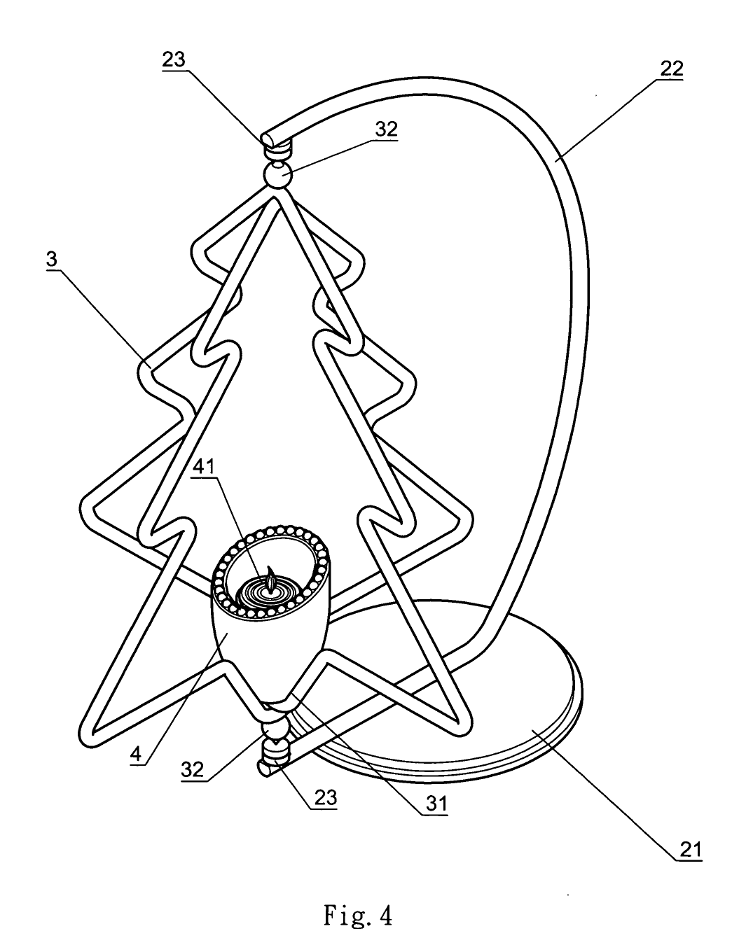

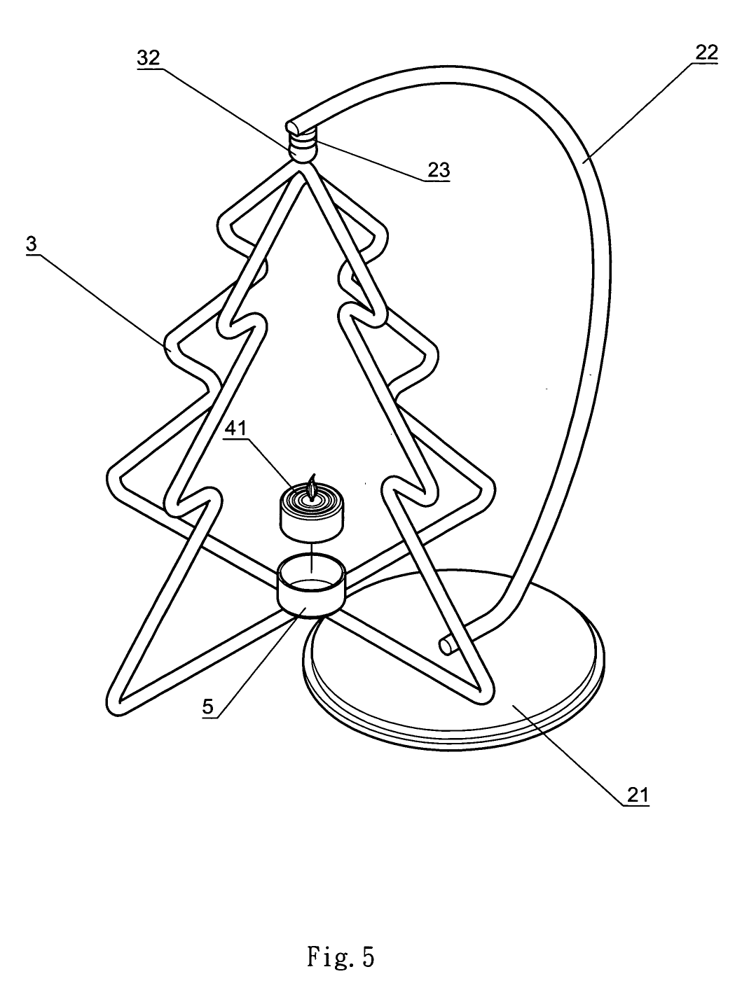

In addition, referring to FIG. 4 and FIG. 5, a spheriform pinnacle 32 can be designed at the upper and lower ends of the candle base holder 3 respectively so as to provide the bidirectional absorption and position to the magnet unit 23 and realize the effect not form centrifugal shaking fixed-point free rotation (as shown in FIG. 4); the present invention fixes the round candle box 5 directly on the bottom center of the candle base holder 3 so as to stabilize the candle box 5 exempting from displacement. No matter how the candle base holder 3 rotates, the candle box 5 would not loosen. Therefore the present invention can improve the stability of placement and application for the candle 41 (as shown in FIG. 5).

In summary, the present invention exactly can make the candle base holder rotate freely by hanging application. Based on the magnetism absorption principle and gravity center allocation, it can rotate stably so as to enhance the burning effect of the candle and make the candlelight take on best optimal beauty by means of dynamics. It is obviously it accords with the requirements of utility model patent.

What is claimed is:

1. A rotary hanging-type candle base holder mainly is composed of candle base and candle base holder, featuring:
the candle base, comprising a chassis of proper weight, whose top side is designed with a bending hanging pole extending upwards. In addition a magnet unit with power magnetism absorption force is designed on the top end of the pole; the candle base holder is a three-dimensional subuliform one, in which its bottom center forms a sunken part 31 while another end top forms a spheriform pinnacle; and
based on the combination of the structures above, the candle base holder may use the end of the spheriform pinnacle to be absorbed on the top side of the magnet unit, so that the handle base holder can be positioned by hanging hollowly. At this time the sunken part can provide the cross placing to stabilize the gravity center of the semi-elliptical candle box, which is used to position the candle. Based on the single-point-type magnetism absorption and position, the candle base holder can rotate freely and good candlelight effects and three-dimensional aesthetic feeling would be obtained.

2. The rotary hanging-type candle base holder, as recited in claim 1, wherein said the spheriform pinnacle can be designed at the upper and lower ends of the candle base holder respectively so as to provide the bidirectional absorption and position to the magnet unit and realize the effect not form centrifugal shaking fixed-point free rotation.

3. The rotary hanging-type candle base holder, as recited in claim 1, wherein said the present invention fixes the round candle box directly on the bottom center of the candle base holder so as to stabilize the candle box exempting from displacement.
